(19) United States
(12) Patent Application Publication
(10) Pub. No.: US 2025/0149764 A1
(43) Pub. Date: May 8, 2025

(54) ENERGY STORAGE APPARATUS

(71) Applicant: GS Yuasa International Ltd., Kyoto (JP)

(72) Inventors: Yosuke NISHIMURA, Kyoto (JP); Minoru WATANABE, Kyoto (JP)

(73) Assignee: GS Yuasa International Ltd., Kyoto (JP)

(21) Appl. No.: 18/833,387

(22) PCT Filed: Jan. 19, 2023
(86) PCT No.: PCT/JP2023/001439

§ 371 Date: Jul. 25, 2024

(30) Foreign Application Priority Data
Jan. 26, 2022 (JP) 2022-009993

(51) Int. Cl. H01M 50/588; H01G 11/10; H01M 50/209; H01M 50/264; H01M 50/593

(52) U.S. Cl. CPC H01M 50/588; H01M 50/209; H01M 50/264; H01M 50/593; H01G 11/10

(57) ABSTRACT

An energy storage apparatus includes: energy storage devices; an elongating member adjacent to the energy storage devices in a first direction; and an insulating member disposed between the energy storage devices and the elongating member. The elongating member includes a first main-body portion and a first piece, the first main-body portion extends in a second direction and a third direction, the first piece elongates from an end of the first main-body portion toward the first direction and elongates in the third direction, the first main-body portion and the first piece are disposed along the energy storage devices, the insulating member includes a second main-body portion and a second piece, the second main-body portion extends along the first main-body portion, the second piece is coupled to an end of the second main-body portion and extends along the first piece, and the first piece and the second piece engage with each other.

### TECHNICAL FIELD

The present invention relates to an energy storage apparatus including a plurality of energy storage devices.

### BACKGROUND ART

A power supply apparatus in which insulating materials are disposed between a plurality of battery cells and bind bars is conventionally known (refer to Patent Literature 1). As illustrated in FIG. 12, this power supply apparatus 500 includes: a battery cell stack 502 in which a plurality of battery cells 501 are stacked; a pair of end plates 503 disposed on both ends in a stacking direction of this battery cell stack 502; and bind bars 504 fixed to the end plates 503.

A battery cell 501 has a plate-like outer shape whose thickness is narrower than its width and whose main surfaces are rectangular shaped. A plurality of such battery cells are stacked. Specifically, the battery cell 501 has an outer can making up its outer shape, which is made in a rectangular shape whose thickness is narrower than its width.

As also illustrated in FIG. 13, the pair of end plates 503 cover both end surfaces of the battery cell stack 502, in a state in which the battery cells 501 are alternately stacked with separators 505 therebetween. This pair of end plates 503 sandwich the battery cell stack 502 by being fixed by the bind bars 504. Each end plate 503 is made up of a single metal plate.

Each bind bar 504 has a main-body plate 506, the both end portions of which are fixed to the end plates 503. As illustrated in FIG. 13, this main-body plates are disposed at both side surfaces of the battery cell stack 502 to which the end plates 503 are stacked to its both ends. The ends of the main-body plates are fixed to the pair of end plates 503.

Specifically, the main-body plate 506 is formed in a plate shape elongating in a stacking direction of the battery cells of battery cell stack 502. More specifically, the main-body plate 506 includes a fastened main surface 507, in a flat plate shape, covering a side surface of the battery cell stack 502. The main-body plate 506 also includes a first bent piece 508, a second bent piece 509, a third bent piece 510, and a fourth bent piece 511, as the pieces resulting by bending the edges of the main-body plate 506.

The first bent piece 508 is a top bent piece resulting by bending a top side of the main-body plate 506. The second bent piece 509 is a bottom bent piece resulting by bending a bottom side of the main-body plate 506, and partially covers each of the corner portions of the lower surface of the battery cell stack 502. The third bent piece 510 is an end-plate fixing piece for fixing the end plate, which is resulting by partially bending a front side of the main-body plate 506. The fourth bent piece 511 is an end-plate fixing piece for fixing the end plate, which is resulting by partially bending a rear side of the main-body plate 506.

This main-body plate 506 is manufactured by a bending process of a metal plate, and is fixed to the end plate 503 with the end-plate fixing piece by screwing.

In the power supply apparatus 500, so as to prevent short-circuiting between the main-body plate 506 made of metal and the outer can of the battery cell 501, an insulation structure may be disposed between the main-body plate 506 and the battery cell stack 502. In the example illustrated in FIG. 13, an insulating material 512 is interposed between the main-body plate 506 made of metal and the battery cell stack 502.

The insulating material 512 is made up of a resin sheet, or the like. The shape of the insulating material 512 is substantially the same as the shape of the main-body plate, and the insulating material 512 serves to prevent the side surface of the battery cell stack from touching the main-body plate. In the example illustrated in FIG. 13, the insulating material 512 is formed in a sheet shape covering substantially all the inner side surface of the main-body plate 506.

In the above-described power supply apparatus, the second bent piece 509 (bottom bent piece) and a portion of the insulating material 512 (corresponding portion) corresponding to the second bent piece simply overlap. Therefore, due to vibration during assemble of the power supply apparatus 500, or during use of the power supply apparatus 500, or the like, the corresponding portion of the insulating material 512, which corresponds to the second bent piece 509, may be deviated (i.e., move) relative to the second bent piece 509. In this way, if the corresponding portion of the insulating material 512, which corresponds to the second bent piece 509, moves relative to the second bent piece 509, sufficient insulation possibly cannot be attained between the battery cell stack 502 and the main-body plate 506.

### CITATION LIST

### Patent Literature

Patent Literature 1: JP-A-2021-26875

### SUMMARY OF INVENTION

### Problems to be Solved by the Invention

In view of the above, an objective of the present embodiment is to provide an energy storage apparatus in which a second piece of an insulating member is hard to move relative to a first piece of an elongating member.

### Means for Solving the Problems

An energy storage apparatus according to the present embodiment includes: a plurality of energy storage devices; an elongating member being adjacent to the plurality of energy storage devices; and an insulating member disposed between the plurality of energy storage devices and the elongating member, where the elongating member includes: a first main-body portion extending in a direction orthogonal to a first direction in which the plurality of energy storage devices align; and a first piece elongating from an end in a second direction orthogonal to the first direction of the first main-body portion toward the first direction and elongating in a third direction orthogonal to each of the first direction and the second direction, each of the first main-body portion and the first piece is disposed along the plurality of energy storage devices, the insulating member includes: a second main-body portion extending along the first main-body portion between the plurality of energy storage devices and the first main-body portion; and a second piece, between the plurality of energy storage devices and the first piece, coupled to an end of the second main-body portion in the second direction and extending along the first piece, and the first piece and the second piece engage with each other.

### Advantages of the Invention

Based on the above, the present embodiment can provide an energy storage apparatus in which a second piece of an insulating member is hard to move relative to a first piece of an elongating member.

### BRIEF DESCRIPTION OF THE DRAWINGS

FIG. 1 is a perspective view of an energy storage apparatus according to the present embodiment.

FIG. 2 is an exploded perspective view of the energy storage apparatus.

FIG. 3 is a sectional view of the energy storage apparatus.

FIG. 4A is an enlarged view of the IV position in FIG. 3.

FIG. 4B is an enlarged sectional view of an energy storage apparatus according to a comparison example.

FIG. 5 is a perspective view of an elongating member of the energy storage apparatus.

FIG. 6 is a side view of the elongating member.

FIG. 7 is a perspective view of an insulating member of the energy storage apparatus.

FIG. 8 is an enlarged view of the VIII position in FIG. 7.

FIG. 9 is a bottom view of the insulating member.

FIG. 10 is a sectional view at the X-X position in FIG. 9.

FIG. 11 is a sectional view at the XI-XI position in FIG. 9.

FIG. 12 is a perspective view of a conventional power supply apparatus.

FIG. 13 is an exploded view of the power supply apparatus.

### MODE FOR CARRYING OUT THE INVENTION

(1) An energy storage apparatus according to the present embodiment includes: a plurality of energy storage devices; an elongating member being adjacent to the plurality of energy storage devices; and an insulating member disposed between the plurality of energy storage devices and the elongating member, where the elongating member includes: a first main-body portion extending in a direction orthogonal to a first direction in which the plurality of energy storage devices align; and a first piece elongating from an end in a second direction orthogonal to the first direction of the first main-body portion toward the first direction and elongating in a third direction orthogonal to each of the first direction and the second direction, each of the first main-body portion and the first piece is disposed along the plurality of energy storage devices, the insulating member includes: a second main-body portion extending along the first main-body portion between the plurality of energy storage devices and the first main-body portion; and a second piece, between the plurality of energy storage devices and the first piece, coupled to an end of the second main-body portion in the second direction and extending along the first piece, and the first piece and the second piece engage with each other.

By the engagement between the first piece and the second piece in this manner, the movement of the second piece relative to the first piece is restrained.
(2) In the energy storage apparatus as stated in (1) above, in the energy storage apparatus according to the present embodiment, the first piece and the second piece may engage with each other in a middle region excluding respective ends in the first direction and the third direction in the first piece.

According to the above-described configuration, the movement of the second piece in the middle region excluding the respective ends in the first direction and the third direction of the first piece can be effectively restrained.
(3) In the energy storage apparatus as stated in (1) or (2) above, in the energy storage apparatus according to the present embodiment, the first piece may include: a first surface opposing the plurality of energy storage devices in the second direction; and a second surface which is a rear surface of the first surface, and the second piece may be disposed between the plurality of energy storage devices and the first piece, in a state in which the second piece does not exceed beyond the second surface in a direction from the second piece towards the first piece.

According to the above-described configuration, compared to a configuration in which a part of the second piece exceeds beyond the second surface of the first piece, the size of the energy storage apparatus in the second direction can be reduced by a size corresponding to a portion exceeding beyond the second surface (i.e., the energy storage apparatus can be made smaller in the second direction).
(4) In the energy storage apparatus as stated in (1) or (2) above, in the energy storage apparatus according to the present embodiment, the first piece may include: a piece main-body including the first surface and the second surface; and an engagement portion protruding from the piece main-body in a direction towards the second piece and engaging with the second piece.

In this way, a simple configuration in which the engagement portion protruding from the piece main-body engages with the second piece helps easily realize a configuration in which the first piece engages with the second piece in a state in which no portion of the second piece exceeds beyond the second surface of the first piece.

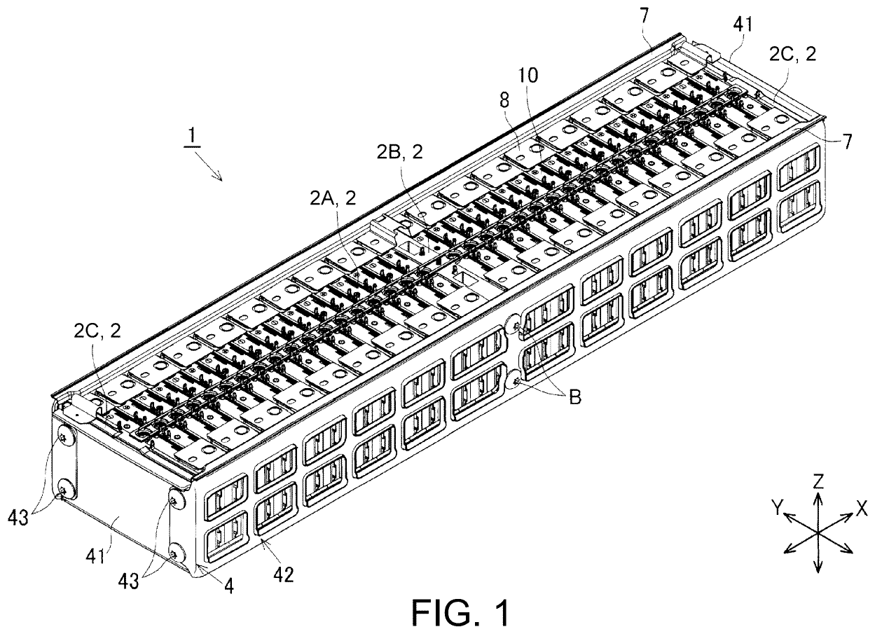

The following describes an embodiment of the present invention with reference to FIG. 1 to FIG. 11. Note that the name of each constituting member (constituting element) of the present embodiment is the name for the present embodiment, and may be different from the name of that constituting member (constituting element) used in BACKGROUND ART.

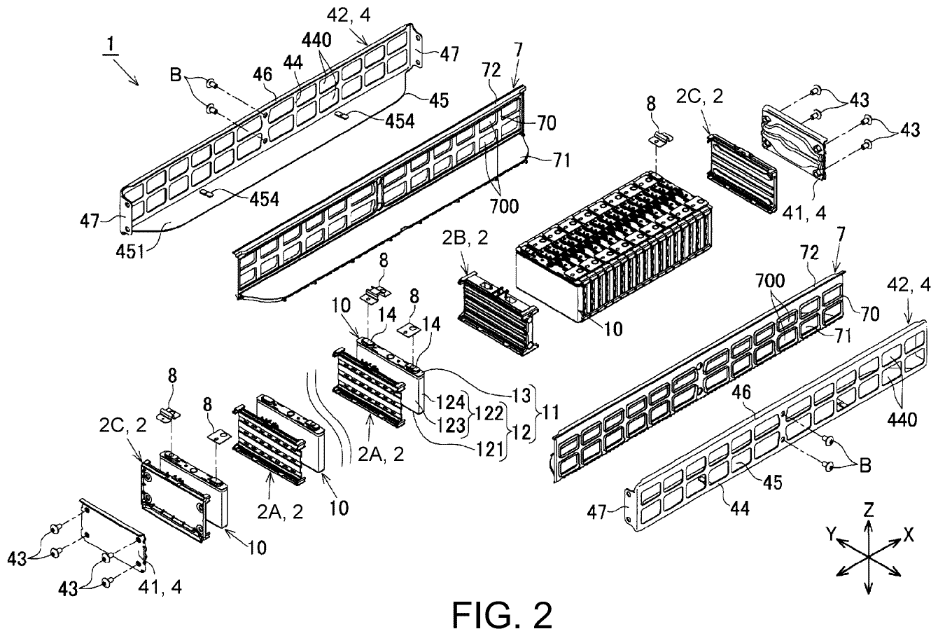

As illustrated in FIG. 1 and FIG. 2, an energy storage apparatus 1 according to the present embodiment includes: a plurality of energy storage devices 10; an elongating member 42 adjacent to the plurality of energy storage devices 10; and an insulating member 7 disposed between the plurality of energy storage devices 10 and the elongating member 42. Specifically, the energy storage apparatus 1 includes: the plurality of energy storage devices 10 aligning in a predetermined direction; a plurality of adjacent members 2 adjacent to the energy storage devices 10 in the predetermined direction; and a holding member 4 including the elongating member 42 and holding the plurality of energy storage devices 10 and the plurality of adjacent members 2.

This energy storage apparatus 1 includes: a first fastening member B to fasten at least one adjacent member 2 to the holding member 4; at least one insulating member 7 to insulate between the plurality of energy storage devices 10 and the holding member 4; and a plurality of bus bars 8 coupling different ones of the energy storage devices 10 to be conductible.

Each of the plurality of energy storage devices 10 is a primary battery, a secondary battery, a capacitor, etc. The energy storage device 10 according to the present embodiment is a chargeable and dischargeable non-aqueous electrolyte secondary battery. More specifically, the energy storage device 10 is a lithium-ion secondary battery which uses electron transfer that takes place as lithium ions transfer.

Specifically, each energy storage device 10 includes: an electrode assembly; a case 11 to accommodate the electrode assembly together with an electrolyte; an external terminal 14 being at least partially exposed outside the case 11; and a current collector to couple the electrode assembly with the external terminal 14.

In the electrode assembly, positive electrodes and negative electrodes are alternately stacked with separators interposed therebetween. The energy storage device 10 charges and discharges, as lithium ions transfer between the positive electrodes and the negative electrodes in the electrode assembly.

The case 11 includes: a case main-body 12 having an opening; and a cover plate 13, in a plate shape, to close (seal) the opening of the case main-body 12. This case main-body 12 has a rectangular cylindrical shape in which one end in the opening direction is closed (i.e., a rectangular cylindrical shape with a bottom), and the case 11 has a rectangular parallelepiped shape (hexahedron shape).

Specifically, the case main-body 12 includes: a closing portion 121 in a plate shape; and a cylindrical drum portion (peripheral wall) 122 to be coupled to a circumference of the closing portion 121.

The closing portion 121 is a portion in a plate shape which is disposed at a bottom end of the case main-body 12, when the case main-body 12 is disposed in such a posture that the opening is oriented upward. That is, the closing portion 121 serves as a bottom wall of the case main-body 12 when the opening is oriented upward. The closing portion 121 has a rectangular plate shape when viewed in a normal direction of the closing portion 121.

The drum portion 122 has a rectangular cylindrical shape. In more detail, the drum portion 122 has a flat rectangular cylindrical shape. The drum portion 122 includes: a pair of long wall portions 123 elongating from the long sides of the circumference of the closing portion 121; and a pair of short wall portions 124 elongating from the short sides of the circumference of the closing portion 121. The long wall portions 123 and the short wall portions 124 respectively have a plate shape (specifically, a rectangular plate shape). In this drum portion 122, the short wall portions 124 are respectively coupled to the corresponding ends of the pair of long wall portions 123, thereby forming the drum portion 122 having a rectangular cylindrical shape.

The cover plate 13 is a member, in a plate shape, to close the opening of the case main-body 12. The cover plate 13 according to the present embodiment has a rectangular shape. This cover plate 13 is joined to the case main-body 12 in a state in which a circumferential portion of the cover plate 13 is overlapped on the opening circumferential portion of the case main-body 12, thereby forming the case 11.

The above-described case 11 has a flat rectangular parallelepiped shape, and the plurality of energy storage devices 10 align in the predetermined direction in a state in which the wide surfaces (the long wall portions 123) of the cases 11 oppose each other.

The external terminal 14 is a portion to be electrically coupled to an external terminal of another energy storage device or to an external device, or the like. The external terminal 14 is formed by a conductive member. For example, the external terminal 14 is formed by a metal material having high weldability, such as an aluminum-based metal material such as aluminum or an aluminum alloy or a copper-based metal material such as copper or a copper alloy. The energy storage device 10 according to the present embodiment includes two external terminals 14, which are disposed at both ends in a longitudinal direction of the cover plate 13.

In the description stated below, the direction in which the plurality of energy storage devices 10 align (the predetermined direction, or third direction) is defined to be X-axis of a rectangular coordinate system, the direction in which the short wall portions 124 of the case 11 oppose is defined to be Y-axis (first direction) of the rectangular coordinate system, and the direction in which the cover plate 13 opposes the closing portion 121 is defined to be Z-axis (second direction). The short wall portion 124 extends both in the Y-axis direction and Z-axis direction. The closing portion 121 extends both in the X-axis direction and the Y-axis direction.

Each of the plurality of bus bars 8 is a conductive member, in a plate shape, such as metal. Each bus bar 8 makes external terminals 14 of energy storage devices 10 conductive to each other. The plurality of bus bars 8 according to the present embodiment couple (conduct), in series, the plurality of energy storage devices 10 included in the energy storage apparatus 1.

The adjacent member 2 has an insulating property and is disposed between the energy storage devices 10 aligning in the X-axis direction, or between an energy storage device 10 and a member aligning relative to the energy storage device 10 in the X-axis direction (a part of a holding member 4 in the example of the present embodiment). The adjacent member 2 according to the present embodiment is formed of resin. A flow path is formed between this adjacent member 2 and an adjacent energy storage device 10, through which a fluid for temperature adjustment (gas such as air in the example of the present embodiment) can flow. The energy storage apparatus 1 according to the present embodiment includes a plurality of adjacent members 2, and the plurality of adjacent members 2 include a plurality of types of adjacent members 2A, 2B, and 2C.

Specifically, the plurality of adjacent members 2 include a first adjacent member 2A disposed between two adjacent energy storage devices 10, a second adjacent member 2B disposed between adjacent energy storage devices 10 and fixed to the holding member 4, and a third adjacent member 2C disposed between the holding member 4 and an energy storage device 10 closest to the end in the X-axis direction to be adjacent to that energy storage device 10. In other words, the energy storage apparatus 1 includes, as the adjacent members 2, the first adjacent member 2A, the second adjacent member 2B, and the third adjacent member 2C. The energy storage apparatus 1 according to the present embodiment includes a plurality of first adjacent members 2A, a single second adjacent member 2B, and two (a pair of) third adjacent members 2C. Each of the plurality of first adjacent members 2A is disposed between energy storage devices 10 excluding between those energy storage devices 10 between which the second adjacent member 2B is disposed. The second adjacent member 2B is fixed to the holding member 4 (specifically, to the elongating member 42) by means of the first fastening members B.

The holding member 4 collectively holds the plurality of energy storage devices 10 and the plurality of adjacent members 2, by enclosing around the plurality of energy storage devices 10 and the plurality of adjacent members 2. This holding member 4 is made up of a conductive member made of metal or the like.

Specifically, the holding member 4 includes: a pair of terminal members 41 disposed at both sides of the plurality of energy storage devices 10 (a stack of the energy storage devices 10) in the X-axis direction; an elongating member 42 elongating in the X-axis direction along the plurality of energy storage devices 10; and a coupling member 43 coupling the terminal member 41 and the elongating member 42. More specifically, the holding member 4 according to the present embodiment includes a pair of elongating members 42. The pair of elongating members 42 are disposed at both sides of the plurality of energy storage devices 10 in the Y-axis direction, and are coupled to the pair of terminal members 41. The holding member 4 according to the present embodiment includes a plurality of coupling members 43.

Each of the pair of terminal members 41 is disposed to sandwich the third adjacent member 2C between that terminal member 41 and the energy storage device 10 that is disposed at an end (outermost end) in the X-axis direction. Each of the pair of terminal members 41 has a rectangular plate shape in a size corresponding to that of the energy storage device 10. Specifically, each terminal member 41 has a rectangular shape which is long in the Y-axis direction.

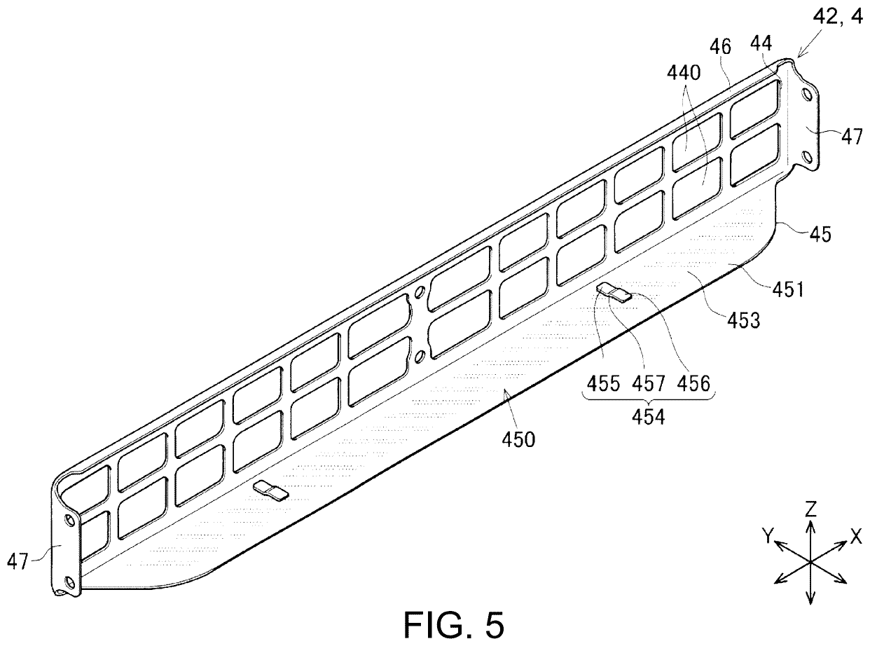

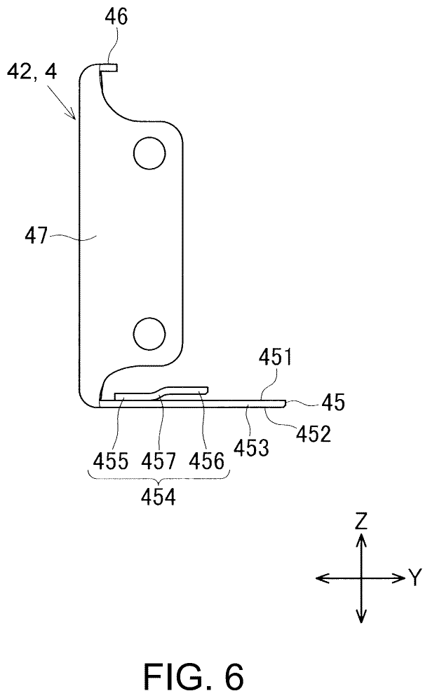

As illustrated in FIG. 5 and FIG. 6, each of the pair of elongating members 42 includes: an elongating side surface portion (first main-body portion) 44 which extends in a direction orthogonal to the Y-axis direction, which is a direction in which the elongating members 42 align with the plurality of energy storage devices 10; and an elongating bottom surface portion (first piece) 45 elongating from an end of the elongating side surface portion 44 in a Z-axis direction orthogonal to the Y-axis direction toward the Y-axis direction and elongating in the X-axis direction orthogonal to each of the Y-axis direction and the Z-axis direction. Each of the elongating side surface portion 44 and the elongating bottom surface portion 45 is disposed along the plurality of energy storage devices 10 (refer to FIG. 2).

In the holding member 4 according to the present embodiment, the elongating bottom surface portion 45 elongates from one end of the elongating side surface portion 44 in the Z direction. Each of the pair of elongating members 42 includes: an elongating top surface portion 46 elongating in the Y-axis direction from an end of the elongating side surface portion 44 in the Z-axis direction orthogonal to the Y-axis direction and elongating in the X-axis direction orthogonal to each of the Y-axis direction and the Z-axis direction; and a pair of elongating end surface portions 47 elongating in the Y-axis direction from each end of the elongating side surface portion 44 in the X-axis direction along the terminal member 41, and elongating in the Z-axis direction.

The elongating side surface portion 44 opposes the short wall portion 124 of each energy storage device 10. The elongating side surface portion 44 has a plate shape extending along the short wall portion 124 of each energy storage device 10, and has a plurality of through holes 440 penetrating therethrough in the Y-axis direction, to allow a temperature adjusting fluid to flow in and out each flow path.

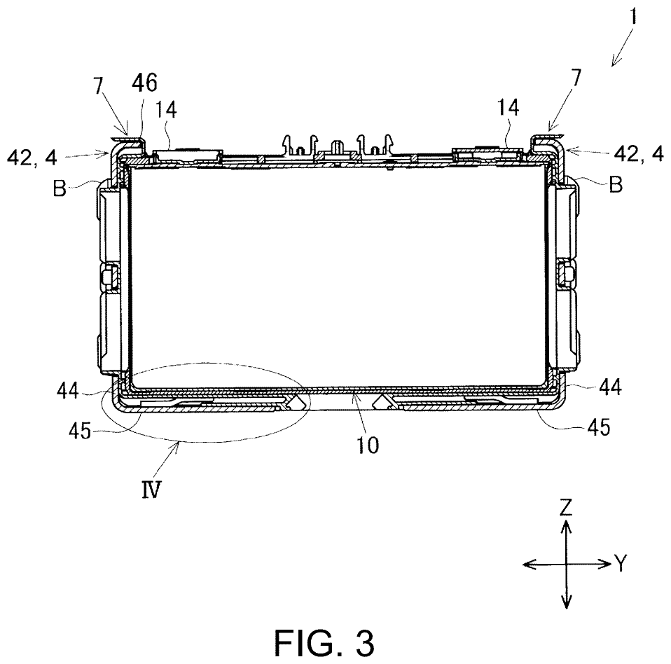

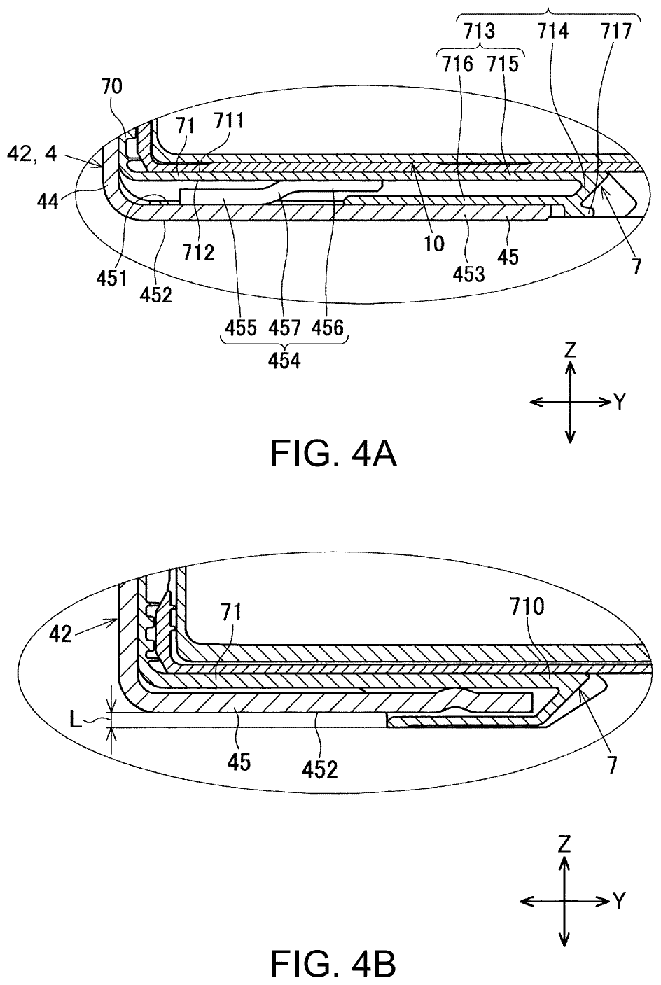

The elongating bottom surface portion 45 elongates in the Y-axis direction from one end of the elongating side surface portion 44 in the Z-axis direction, along the closing portion 121 of each energy storage device 10, and elongates in the X-direction. The elongating bottom surface portion 45 has a band shape which is long in the X-axis direction, and has a constant size (width) in the Y-axis direction at each position, excluding at both ends in the X-axis direction. As illustrated in FIG. 3 and FIG. 4A, the elongating bottom surface portion 45 includes: a first surface 451 opposing the plurality of energy storage devices 10 in the Z-axis direction; and a second surface 452 which is a rear surface of the first surface 451. In the elongating member 42 according to the present embodiment, each of the first surface 451 and the second surface 452 of the elongating bottom surface portion 45 is a flat surface.

In the energy storage apparatus 1 according to the present embodiment, the elongating bottom surface portion 45 includes: a piece main-body 453 which includes the first surface 451 and the second surface 452; and an engagement portion 454 protruding in a direction (upward in FIG. 4A) from the piece main-body 453 towards the insulating member 7 and engaging with the insulating member 7.

The piece main-body 453 elongates in the Y-axis direction from one end of the elongating side surface portion 44 in the Z-axis direction along the closing portion 121 of each energy storage device 10, and elongates in the X-axis direction (refer to FIG. 5).

The engagement portion 454 is a protruding portion protruding towards the energy storage devices 10 from a middle region 450 excluding respective ends in the X-axis direction and the Y-axis direction of the piece main-body 453. The engagement portion 454 elongates in the Z-axis direction.

In the elongating bottom surface portion 45 according to the present embodiment, a first surface of the piece main-body 453, which opposes the plurality of energy storage devices 10 in the Z-axis direction, constitutes the first surface 451 of the elongating bottom surface portion 45, and a second surface of the piece main-body 453, which is a rear surface of the first surface, constitutes the second surface 452 of the elongating bottom surface portion 45.

In the elongating bottom surface portion 45 according to the present embodiment, a plurality of engagement portions 454 are disposed with an interval therebetween in the X-axis direction. The exemplary number of engagement portions 454 disposed is two. Note that the number of engagement portion 454 disposed on the elongating bottom surface portion 45 may be one. The engagement portion 454 is a portion having a plate shape (e.g., a portion having a rectangular plate shape).

An end of the engagement portion 454 in the Z-axis direction engages with the insulating member 7. Specifically, the engagement portion 454 includes a base portion 455 coupled with the piece main-body 453; a tip end portion 456 to engage with the insulating member 7; and a coupling portion 457 to couple with the base portion 455 and the tip end portion 456. In this engagement portion 454, the base portion 455, the coupling portion 457, and the tip end portion 456 consecutively align in the Z-axis direction, in the stated order from the farthest side from the energy storage devices 10.

Each of the base portion 455 and the tip end portion 456 is a portion having a flat plate shape, elongating in the X-axis direction, and elongating in the Y-axis direction (refer to FIG. 6). The coupling portion 457 is a portion having a flat plate shape and elongating at an angle relative to the base portion 455 and the tip end portion 456. The coupling portion 457 is disposed with an interval from the piece main-body 453 in the Z-axis direction.

The elongating top surface portion 46 elongates in the Y-axis direction from the other end of the elongating side surface portion 44 in the Z-axis direction along the cover plate 13 of each energy storage device 10, and elongates to the X-axis direction. The elongating top surface portion 46 has a band shape which is long in the X-axis direction, and has a constant size (width) in the Y-axis direction at each position, excluding at both ends in the X-axis direction. The width of this elongating top surface portion 46 is smaller than the width of the elongating bottom surface portion 45 (refer to FIG. 3).

The insulating member 7 has an insulating property. This insulating member 7 is disposed between the elongating member 42 and the plurality of energy storage devices 10. The energy storage apparatus 1 according to the present embodiment includes a pair of insulating members 7. Each of the insulating members 7 covers a respective region of the elongating member 42, which at least opposes the plurality of energy storage devices 10. As a result, each insulating member 7 insulates between the elongating member 42 and the plurality of energy storage devices 10.

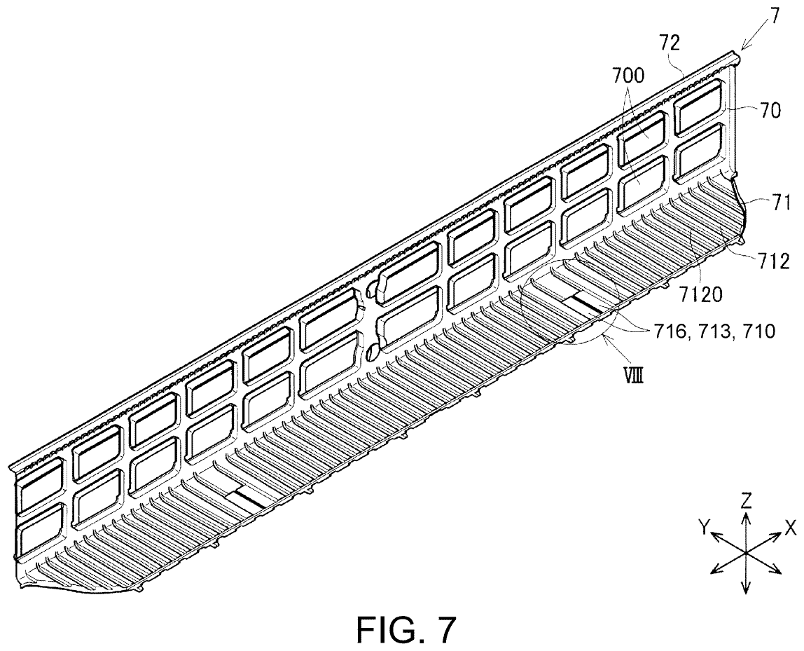

Specifically, as illustrated in FIG. 2, and FIG. 7 to FIG. 10, the insulating member 7 includes: an insulating side surface portion (second main-body portion) 70 disposed between the plurality of energy storage devices 10 and the elongating side surface portion 44 of the elongating member 42, and extending along the elongating side surface portion 44; and an insulating bottom surface portion (second piece) 71 disposed between the plurality of energy storage devices 10 and the elongating bottom surface portion 45, coupled to an end of the insulating side surface portion 70 in the Z-axis direction, and extending along the elongating bottom surface portion 45.

In the insulating member 7 according to the present embodiment, the insulating bottom surface portion 71 elongates from one end of the insulating side surface portion 70 in the Z-axis direction. The insulating member 7 includes an insulating top surface portion 72 elongating in the Y-axis direction from an end of the insulating side surface portion 70 in the Z-axis direction orthogonal to the Y-axis direction, and elongating in the X-axis direction orthogonal to each of the Y-axis direction and the Z-axis direction.

The insulating side surface portion 70 opposes the short wall portion 124 of each energy storage device 10. The insulating side surface portion 70 has a plate shape extending along the short wall portion 124 of each energy storage device 10, and includes through holes 700, at positions in each insulating member 7 corresponding to the positions of the respective through holes 440 of the elongating side surface portion 44. The through holes 700 have a size and a shape corresponding to those of the respective through holes 440 of the elongating side surface portion 44. The insulating side surface portion 70 is sandwiched between the short wall portions 124 of the energy storage devices 10 and the elongating side surface portion 44 of the elongating member 42 in the Y-axis direction.

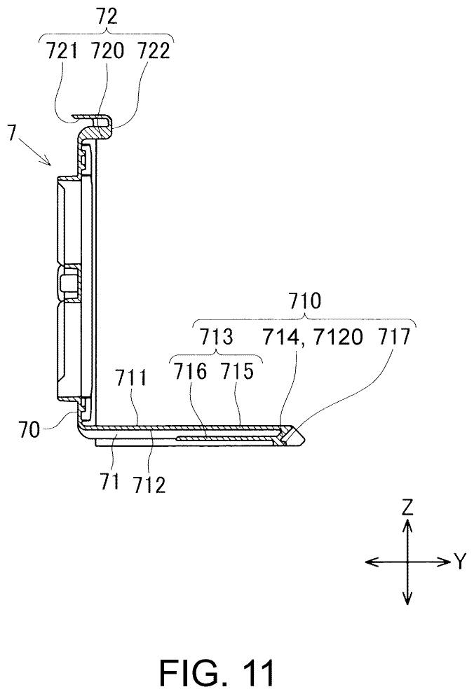

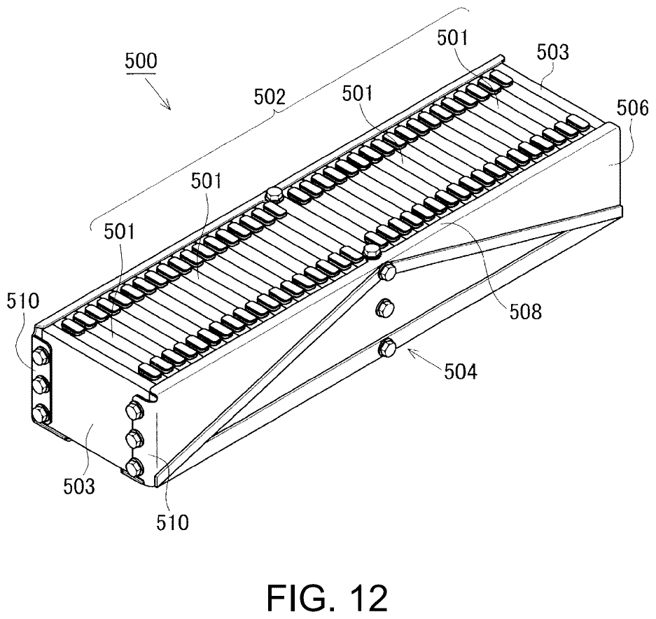

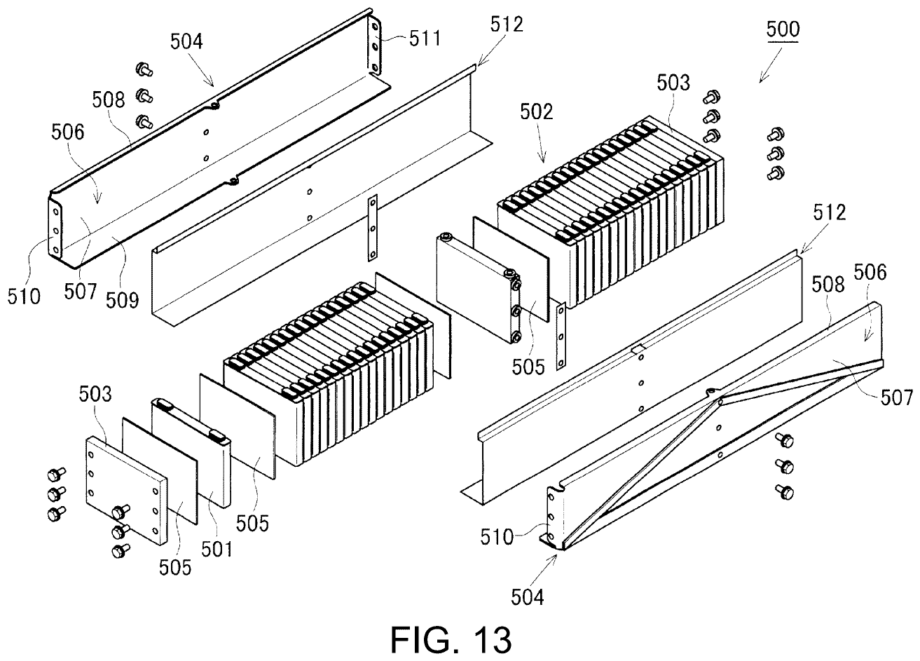

The insulating top surface portion 72 elongates in the Y-axis direction from the other end of the insulating side surface portion 70 in the Z-axis direction along the cover plate 13 of each energy storage device 10, and elongates in the X-axis direction. The insulating top surface portion 72 has a band shape which is long in the X-axis direction, and has a constant size (width) in the Y-axis direction at each position, excluding at both ends in the X-axis direction. The width of this insulating top surface portion 72 is smaller than the width of the insulating bottom surface portion 71, as illustrated in FIG. 11.

The insulating top surface portion 72 includes: a first portion 720 continuous to the other end of the insulating side surface portion 70 in the Z-axis direction; a second portion 721 covering, together with the first portion 720, a front surface and a rear surface of the elongating top surface portion 46; and a third portion 722 coupling the first portion 720 and the second portion 721, and covering an edge of the elongating top surface portion 46.

The insulating bottom surface portion 71 elongates in the Y-axis direction from one end of the insulating side surface portion 70 in the Z-axis direction, along the closing portion 121 of each energy storage device 10, and elongates in the X-axis direction. The insulating bottom surface portion 71 has a band shape which is long in the X-axis direction, and has a constant size (width) in the Y-axis direction at each position, excluding at both ends in the X-axis direction. The insulating bottom surface portion 71 includes: a first surface 711 opposing the plurality of energy storage devices 10 in the Z-axis direction; and a second surface 712 which is a rear surface of the first surface 711.

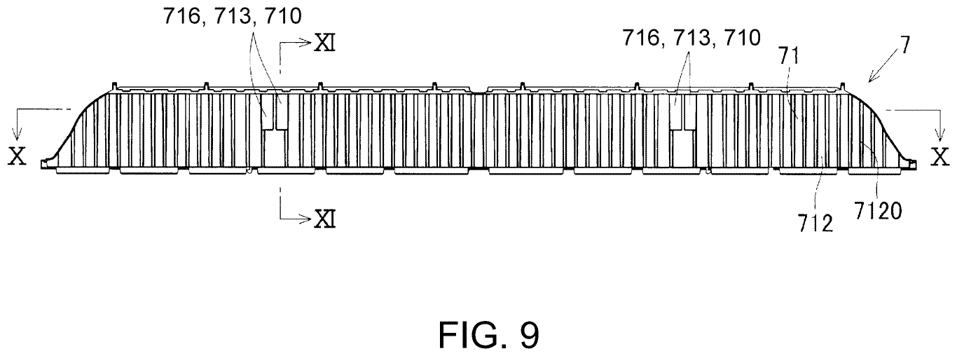

In the insulating member 7 according to the present embodiment, the first surface 711 of the insulating bottom surface portion 71 is a flat surface. The second surface 712 of the insulating bottom surface portion 71 is a surface having irregularities, as illustrated in FIG. 9. Specifically, the insulating bottom surface portion 71 includes a rib 7120 elongating in the Y-axis direction and protruding away from the energy storage devices 10 in the Z-axis direction. A plurality of ribs 7120 are disposed with an interval therebetween in the X-axis direction.

A direction from the piece main-body 453 towards the insulating bottom surface portion 71 corresponds to a direction in which the engagement portion 454 protrudes (upward in FIG. 4A). The insulating bottom surface portion 71 engages with the engagement portion 454.

The insulating bottom surface portion 71 engages with the elongating bottom surface portion 45 (refer to FIG. 4A). Specifically, the elongating bottom surface portion 45 engages with the insulating bottom surface portion 71 so as to restrict movement in which the elongating bottom surface portion 45 and the insulating bottom surface portion 71 are separated from each other (the Z-axis direction). In this energy storage apparatus 1, the insulating bottom surface portion 71 engages with the elongating bottom surface portion 45 in the middle region 450 excluding respective ends in the Y-axis direction and the X-axis direction of the elongating bottom surface portion 45 (refer to FIG. 5).

The insulating bottom surface portion 71 engages with the elongating bottom surface portion 45 in the middle region 450 in the X-axis direction and the Y-axis direction, out of a region in which a stack of the plurality of energy storage devices 10 and the plurality of adjacent members 2 is disposed. Specifically, when considering the elongating member 42 in a fixed position as a reference, the insulating bottom surface portion 71 engages with the elongating bottom surface portion 45, in a region between the position in which the insulating member 7 is fixed to the elongating member 42 with the first fastening members B and the position in which the terminal member 41 is fixed to the elongating member 42 with the coupling member 43, excluding respective ends in the X-axis direction and the Y-axis direction. When considering the adjacent member 2 as a reference, the insulating bottom surface portion 71 engages with the elongating bottom surface portion 45, in a region between the position of the second adjacent member 2B and the position of the third adjacent member 2C, excluding respective ends in the X-axis direction and the Y-axis direction.

Specifically, the insulating bottom surface portion 71 is disposed between the plurality of energy storage devices 10 and the elongating bottom surface portion 45, in a state in which the insulating bottom surface portion 71 does not exceed beyond the second surface 452 in a direction from the insulating bottom surface portion 71 towards the elongating bottom surface portion 45 (downward in FIG. 4A) (i.e., in a state in which the insulating bottom surface portion 71 is positioned closer to the energy storage devices 10 in the Z-axis direction than the second surface 452 is). More specifically, the entire insulating bottom surface portion 71 is covered by the elongating bottom surface portion 45 from a position far from the energy storage device 10 in the Z-axis direction. The insulating bottom surface portion 71 is sandwiched between the closing portions 121 of the energy storage devices 10 and the elongating bottom surface portion 45 of the elongating member 42, in the Z-axis direction.

In the insulating member 7 according to the present embodiment, the insulating bottom surface portion 71 includes, at its elongation end, an accommodation portion 710 to accommodate the tip end portion 456 of the engagement portion 454. As also illustrated in FIG. 7, a plurality of accommodation portions 710 are disposed with an interval therebetween in the X-axis direction. The exemplary number of accommodation portions 710 disposed is two.

The accommodation portion 710 is a portion having a bag shape covering the engagement portion 454. A size of the accommodation portion 710 in the X-axis direction is one size greater than a size of the engagement portion 454 in the X-axis direction. The engagement portion 454 is inserted into the accommodation portion 710 in the Y-axis direction. The accommodation portion 710 according to the present embodiment includes: a pair of cover portions 713 covering the tip end portion 456 from both sides in the Z-axis direction; a coupling rib 714, among the ribs 7120, coupled to the pair of cover portions 713 (one cover portion 715 and the other cover portion 716), and covering a side surface of the tip end portion 456. The accommodation portion 710 includes an elongation portion 717 elongating from the other cover portion 716 to farther away from the energy storage devices 10 in the Z-axis direction.

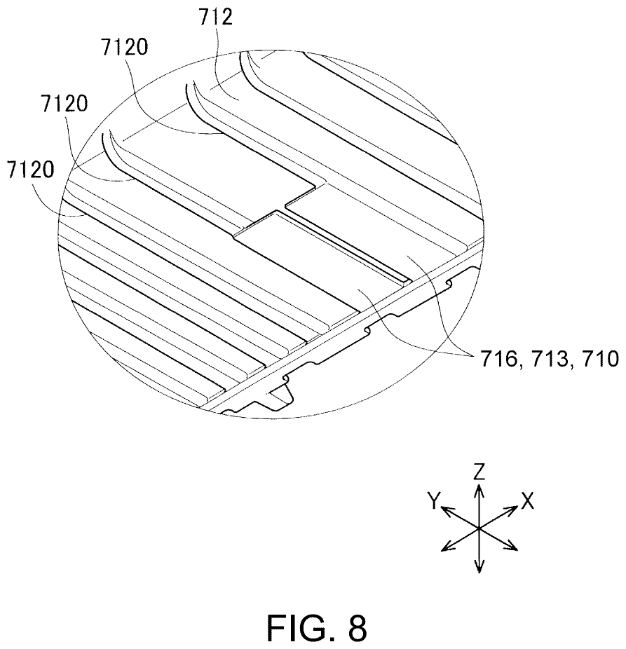

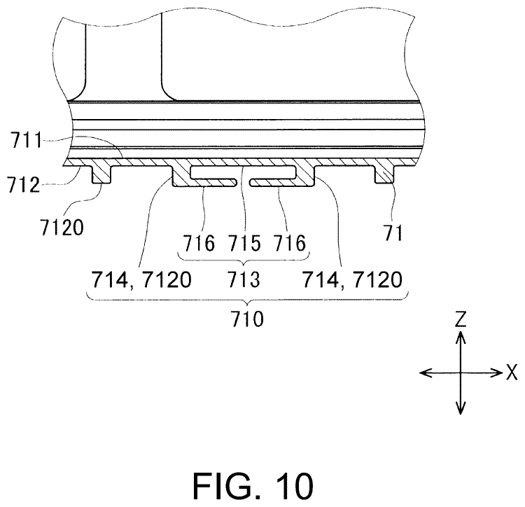

The one cover portion 715, of the pair of cover portions 713, is disposed closer to the energy storage devices 10 in the Z-axis direction. The other cover portion 716, of the pair of cover portions 713, is disposed farther from the energy storage device 10 in the Z-axis direction. In each accommodation portion 710, a pair of other cover portions 716 are disposed with an interval therebetween in the X-axis direction. As illustrated in FIG. 8 and FIG. 10, the cover portion 716 is made of two pieces disposed to oppose each other, to be close to each other from one tip end in the Z-axis direction of the two ribs 7120 adjacent to each other in the X-axis direction towards one side and the other side in the X-axis direction. Note that the tip ends of these two cover portions 716 in the X-axis direction are not in contact with each other but are separate from each other, and an interval in a slit shape is formed between the two cover portions 716. This will prevent shrinkage from occurring in the accommodation portion 710 in molding of the insulating member 7 with a resin material. As illustrated in FIG. 4A and FIG. 7 to FIG. 9, the cover portion 716 is formed from a center portion of the insulating bottom surface portion 71 in the Y-axis direction up to its tip end farther from the insulating side surface portion 70. The cover portion 716 is not formed in a side towards closer to insulating side surface portion 70 from the center portion of the insulating bottom surface portion 71 in the Y-axis direction. The tip end portion 456 of the engagement portion 454 is inserted from the region in which this cover portion 716 is not formed, along the Y-axis direction and into the accommodation portion 710.

The elongation portion 717 is adjacent to the piece main-body 453 of the elongating bottom surface portion 45 in the Y-axis direction. The elongation portion 717 elongates along a circumference of the elongating bottom surface portion 45, from one end to the other end in the X-axis direction.

According to the above-described energy storage apparatus 1, the elongating bottom surface portion 45 of the elongating member 42 engages with the insulating bottom surface portion 71 of the insulating member 7, thereby restraining the movement of insulating bottom surface portion 71 relative to the elongating bottom surface portion 45. In the energy storage apparatus 1 according to the present embodiment, the elongating bottom surface portion 45 engages with the insulating bottom surface portion 71, in such a way to restrict the movement in the Z-axis direction. Therefore, the movement of the insulating bottom surface portion 71 relative to the elongating bottom surface portion 45 in the Z-axis direction is restrained.

Since the movement of the insulating bottom surface portion 71 relative to the elongating bottom surface portion 45 in the Z-axis direction is restrained, lift of the insulating bottom surface portion 71 relative to the elongating bottom surface portion 45 is restrained at the manufacture of the energy storage apparatus 1.

In the energy storage apparatus 1 according to the present embodiment, engagement between the engagement portion 454 and the accommodation portion 710 cannot restrain relative movement between the elongating bottom surface portion 45 and the insulating bottom surface portion 71 in the X-axis direction or in the Y-axis direction. However, because the elongation portion 717 of the insulating bottom surface portion 71 is adjacent to the piece main-body 453 of the elongating bottom surface portion 45 in the Y-axis direction, the relative movement in the Y-axis direction can be restrained. Since the elongation portion 717 elongates along the circumference of the elongating bottom surface portion 45 from one end to the other end in the X-axis direction, the relative movement in the X-axis direction can be restrained.

In the energy storage apparatus 1 according to the present embodiment, the elongating bottom surface portion 45 engages with the insulating bottom surface portion 71, in the middle region 450 excluding the respective ends in the Y-axis direction and the X-axis direction of the elongating bottom surface portion 45. Therefore, the movement of the insulating bottom surface portion 71 in this middle region 450 can be effectively restrained.

In the energy storage apparatus 1 according to the present embodiment, the insulating bottom surface portion 71 is disposed between the plurality of energy storage devices 10 and the elongating bottom surface portion 45, in a state in which the insulating bottom surface portion 71 does not exceed beyond the second surface 452 of the elongating bottom surface portion 45 in the Z-axis direction. Therefore, compared to a configuration in which a part of the insulating bottom surface portion 71 exceeds beyond the second surface 452 of the elongating bottom surface portion 45 as illustrated in FIG. 4B, the size of the energy storage apparatus 1 in the Z-axis direction can be reduced by a size L, which corresponds to the portion exceeding beyond the second surface 452 (i.e., the energy storage apparatus 1 can be made smaller in the Z-axis direction).

The energy storage apparatus 1 according to the present embodiment has a simple configuration in which the engagement portion 454 protruding from the piece main-body 453 of the elongating bottom surface portion 45 engages with the insulating bottom surface portion 71, to easily realize a configuration in which the elongating bottom surface portion 45 engages with the insulating bottom surface portion 71 in a state in which no portion of the insulating bottom surface portion 71 exceeds beyond the second surface 452 of the elongating bottom surface portion 45.

It is needless to say that the energy storage apparatus 1 according to the present invention is not limited to the above-described embodiment, and various modifications can be made thereto within a scope not departing from the essence of the present invention. A configuration of another embodiment can be added to a configuration of an embodiment, and a part of a configuration of an embodiment can be replaced with a configuration of another embodiment. A part of a configuration of an embodiment can be omitted.

In the above-described embodiment, the elongating bottom surface portion 45 engages with the insulating bottom surface portion 71, in the middle region 450 excluding the respective ends in the Y-axis direction and the X-axis direction of the elongating bottom surface portion 45. However, the elongating bottom surface portion 45 may engage with the insulating bottom surface portion 71, at respective ends of the elongating bottom surface portion 45 in the Y-axis direction and the X-axis direction. In this case, the elongating bottom surface portion 45 can engage with the insulating bottom surface portion 71, at both ends of the elongating bottom surface portion 45 in the Y-axis direction and at both ends of the elongating bottom surface portion 45 in the X-axis direction.

In the above-described embodiment, the insulating bottom surface portion 71 is disposed between the plurality of energy storage devices 10 and the elongating bottom surface portion 45, in a state in which the insulating bottom surface portion 71 does not exceed beyond the second surface 452 of the elongating bottom surface portion 45 in the Z-axis direction. However, the insulating bottom surface portion 71 may be disposed between the plurality of energy storage devices 10 and the elongating bottom surface portion 45, in a state in which a part of the insulating bottom surface portion 71 exceeds beyond the second surface 452 of the elongating bottom surface portion 45 in the Z-axis direction.

In the above-described embodiment, the engagement portion 454 protruding from the piece main-body 453 of the elongating bottom surface portion 45 engages with the insulating bottom surface portion 71. However, the elongating bottom surface portion 45 may be engaged with the insulating bottom surface portion 71 by a different configuration. An engagement portion protruding from the insulating bottom surface portion 71 may be engaged with the elongating bottom surface portion 45.

In the above-described embodiment, the insulating bottom surface portion 71 includes, at its elongation end, the accommodation portion 710 having a bag shape to accommodate the tip end portion 456 of the engagement portion 454. However, instead of having a bag shape, the accommodation portion 710 may have a band shape (an annular shape). The engagement portion 454 is inserted into the accommodation portion 710 in the Y-axis direction. However, the engagement portion 454 may be inserted in a different direction (the X-axis direction, etc.). The accommodation portion 710 may be formed without using the ribs 7120 (specifically, the coupling rib 714).

In the accommodation portion 710, the pair of cover portions 713 may be coupled with the ribs 7120, by a separately disposed coupling portion. The pair of accommodation portions 710 are disposed with an interval therebetween in the X-axis direction. However, the number of accommodation portion 710 disposed may be one, or the accommodation portions 710 may be disposed consecutively in the Y-axis direction.

In the above-described embodiment, the elongating bottom surface portion 45 of the elongating member 42 engages with the insulating bottom surface portion 71. However, instead of the elongating bottom surface portion 45, a different portion (e.g., elongating top surface portion 46) of the elongating member 42 may be engaged with a different portion (e.g., insulating top surface portion 72) of the insulating member 7.

In the above-described embodiment, the member adjacent to the plurality of energy storage devices 10 is a member (elongating member 42) adjacent in a direction (the Y-axis direction) orthogonal to the stacking direction of the energy storage devices 10. However, the member adjacent to the plurality of energy storage devices 10 may be a member (e.g., the terminal member 41 in the example of the above-described embodiment) adjacent in the stacking direction (axial direction) of the energy storage devices 10. Specifically, the terminal member 41 engages with the insulating member 7. More specifically, the terminal member 41 includes: a terminal main-body portion (first main-body portion) having a rectangular plate shape in a size corresponding to that of the energy storage device 10 and extending in a direction orthogonal to the Y-axis direction; and a terminal bottom surface portion (first piece) elongating from an end of the terminal main-body portion in the Z-axis direction toward the Y-axis direction and elongating in the X-axis direction orthogonal to each of the Y-axis direction and the Z-axis direction. The insulating member 7 includes: a first portion disposed between the terminal member (the terminal main-body portion and the insulating bottom surface portion) and the stack of the energy storage devices 10, and disposed between the terminal main-body portion and the stack of the energy storage devices 10; and a second portion disposed between the terminal bottom surface portion and the stack.

The terminal bottom surface portion engages with the second portion of the insulating member 7.

In the above-described embodiment, the energy storage apparatus includes the energy storage device having a rectangular cylindrical shape. However, the energy storage apparatus may include a laminate-type energy storage device. A laminate-type energy storage device includes, instead of a case, a sealed container accommodating an electrode assembly together with an electrolyte. The sealed container is constituted by a laminate film. The outline of this laminate-type energy storage device, when viewed from the X-axis direction, has a shape including: a first side elongating along the Z-axis direction; and a second side being adjacent to the first side and elongating in the Y-axis direction. The first side sandwiches, together with the elongating side surface portion 44 of the elongating member 42, the insulating side surface portion 70 of the insulating member 7, in the Y-axis direction. The second side sandwiches, together with the elongating bottom surface portion 45 of the elongating member 42, the insulating bottom surface portion 71 of the insulating member 7, in the Z-axis direction.

In the above-described embodiment, the energy storage device is used as a chargeable and dischargeable non-aqueous electrolyte secondary battery (e.g., lithium-ion secondary battery). However, the energy storage device may be of any type and size (capacity). In the above-described embodiment, a lithium-ion secondary battery was described as an example of the energy storage device. However, the energy storage device is not limited to this. The present invention is also applicable to energy storage devices of various secondary batteries, primary batteries, and capacitors such as electric double layer capacitors.

### DESCRIPTION OF REFERENCE NUMERALS

1 . . . energy storage apparatus
2 . . . adjacent member
2A . . . first adjacent member (adjacent member)
2B . . . second adjacent member (adjacent member)
2C . . . third adjacent member (adjacent member)
4 . . . holding member
7 . . . insulating member
8 . . . bus bars
10 . . . energy storage device
11 . . . case
12 . . . case main-body
13 . . . cover plate
14 . . . external terminal
41 . . . terminal member
42 . . . elongating member
43 . . . coupling members
44 . . . elongating side surface portion (first main-body portion)
45 . . . elongating bottom surface portion (first piece)
46 . . . elongating top surface portion
47 . . . elongating end surface portion
70 . . . insulating side surface portion (second main-body portion)
71 . . . insulating bottom surface portion (second piece)
72 . . . insulating top surface portion
121 . . . closing portion
122 . . . drum portion (peripheral wall)
123 . . . long wall portion
124 . . . short wall portion
440 . . . through hole
450 . . . middle region
451 . . . first surface
452 . . . second surface
453 . . . piece main-body
454 . . . engagement portion
455 . . . base portion
456 . . . tip end portion
457 . . . coupling portion
500 . . . power supply apparatus
501 . . . battery cell
502 . . . battery cell stack
502 . . . battery cell
503 . . . end plate
504 . . . bind bar
505 . . . separator
506 . . . main-body plate
507 . . . fastened main surface
508 . . . first bent piece
509 . . . second bent piece
510 . . . third bent piece
511 . . . fourth bent piece
512 . . . insulating material
700 . . . through hole
710 . . . accommodation portion
711 . . . first surface
712 . . . second surface
713, 715, 716 . . . cover portion
714 . . . coupling rib
720 . . . first portion
721 . . . second portion
722 . . . third portion
7120 . . . rib
B . . . first fastening member

1. An energy storage apparatus comprising:
a plurality of energy storage devices;
an elongating member being adjacent to the plurality of energy storage devices in a first direction; and
an insulating member disposed between the plurality of energy storage devices and the elongating member, wherein
the elongating member includes a first main-body portion and a first piece,
the first main-body portion extends in a second direction that intersects the first direction, and in a third direction that intersects both the first direction and the second direction,
the first piece elongates from an end in the second direction of the first main-body portion toward the first direction and elongates in the third direction,
each of the first main-body portion and the first piece is disposed along the plurality of energy storage devices,
the insulating member includes a second main-body portion and a second piece,
the second main-body portion extends along the first main-body portion between the plurality of energy storage devices and the first main-body portion,
between the plurality of energy storage devices and the first piece, the second piece is coupled to an end in the second direction of the second main-body portion and extends along the first piece, and
the first piece and the second piece engage with each other.

2. The energy storage apparatus according to claim 1, wherein
the first piece and the second piece engage with each other in a middle region excluding respective ends in the first direction and the third direction in the first piece.

3. The energy storage apparatus according to claim 1, wherein
the first piece includes: a first surface opposing the plurality of energy storage devices in the second direction; and a second surface which is a rear surface of the first surface, and
the second piece is disposed between the plurality of energy storage devices and the first piece, in a state in which the second piece does not exceed beyond the second surface in a direction from the second piece towards the first piece.

4. The energy storage apparatus according to claim 3, wherein
the first piece includes: a piece main-body including the first surface and the second surface; and an engagement portion protruding from the piece main-body in a direction towards the second piece and engaging with the second piece.
